(19) United States
(12) Patent Application Publication
(10) Pub. No.: US 2003/0090429 A1
(43) Pub. Date: May 15, 2003

(54) Arranging method for receiving antenna of communication device

(75) Inventors: Hideki Masudaya, Miyagi-ken (JP); Tsuyosi Sato, Tokyo (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/293,849

(22) Filed: Nov. 13, 2002

(30) Foreign Application Priority Data
Nov. 15, 2001 (JP) 2001-350447

(51) Int. Cl. H01Q 7/08

(52) U.S. Cl. 343/788; 343/787; 343/702

(57) ABSTRACT

A receiving antenna is formed by disposing two ferrite chip antenna elements adjacently to each other. The two ferrite chip antenna elements are disposed in combination so that a magnetic flux passing through the central axis of one of the ferrite chip antenna elements does not pass through that of the other of the ferrite chip antenna elements. Herein, the two ferrite chip antenna elements are disposed in combination so as to intersect each other substantially at right angles in a state in which one end portion of one of the ferrite chip antenna elements is opposed to a side surface portion of the other of the ferrite chip antenna elements.

### BACKGROUND OF THE INVENTION

1. Field of the Invention

The present invention relates to an arranging method for a receiving antenna of a communication device. Particularly, the present invention relates to an arranging method for a receiving antenna of a communication device in which, when two ferrite chip antenna elements are to be arranged in combination, they are disposed in combination so that a magnetic flux passing through the central axis of one of the ferrite chip antenna elements does not pass through that of the other of the ferrite chip antenna elements, to achieve a satisfactory resonance characteristic in each of the ferrite chip antenna elements.

2. Description of the Related Art

Conventionally, the passive remote keyless entry device includes an on-vehicle transceiver mounted on a car and one or more mobile transceivers that the car owner and the like carries, and it performs transmission/reception of a wireless signal between the on-vehicle transceiver and the one or more mobile transceivers, during usage. In this type of passive remote keyless entry device, when a wireless signal is to be transmitted from the one or more mobile transceivers to the on-vehicle transceiver, a high-frequency wireless signal is used so that the wireless signal reaches a relatively long distance even by a low power transmission. However, when a wireless signal is to be transmitted from the on-vehicle transceiver to the mobile transceivers, a wireless signal in a frequency band of 100 to 150 kHz is usually used so as to limit the longitudinal coverage of the wireless signal, in order to reduce to a minimum the effect of the wireless signal transmitted by the on-vehicle transceiver upon other devices. The mobile transceiver side is provided with a receiving antenna for receiving this wireless signal. In many cases, such an antenna has a structure in which two or more compact ferrite chip antenna elements (antenna elements each formed by winding wiring around a bar-shaped ferrite core) are combined, in order to reliably receive wireless signals. As the received signal from these ferrite chip antenna elements, a received signal from the ferrite chip antenna elements that have received a wireless signal with the maximum electric field strength is selectively extracted, and therefore, it is possible to receive the wireless signal with relatively high sensitivity.

FIG. 6 is a circuit construction view showing one example of a configuration of the main section of a known receiving antenna formed by combining two antenna elements, the circuit construction view being partially represented as a block diagram.

As illustrated in FIG. 6, the known antenna includes a first ferrite chip antenna element 61, a second ferrite chip antenna element 62, a first resonance capacitor 63 connected in parallel to the first ferrite chip antenna element 61, a second resonance capacitor 64 connected in parallel to the second ferrite chip antenna element 62, a first differential amplifier 65, a second differential amplifier 66, a first level detector 67, a second level detector 68, a signal selector 69, and a signal output terminal 70. Here, a first parallel resonant circuit 71 is constituted of the first ferrite chip antenna element 61 and the first resonance capacitor 63, and a second parallel resonant circuit 72 is constituted of the second ferrite chip antenna element 62, and the second resonance capacitor 64. A signal receiving section 73 comprises the first differential amplifier 65, the second differential amplifier 66, the first level detector 67, the second level detector 68, the signal selector 69, and the signal output terminal 70.

In the first differential amplifier 65, the first input end thereof is connected to one end of the first parallel resonant circuit 71, the second input end thereof is connected to the other end of the first parallel resonant circuit 71, and the output end thereof is connected to the input end of the first level detector 67 and the first input end of the signal selector 69. In the second differential amplifier 66, the first input end thereof is connected to one end of the second parallel resonant circuit 72, the second input end thereof is connected to the other end of the second parallel resonant circuit 72, and the output end thereof is connected to the input end of the second level detector 68 and the second input end of the signal selector 69. In the first level detector 67, the output end thereof is connected to the first control end of the signal selector 69, and in the second level detector 68, the output end thereof is connected to the second control end of the signal selector 69. In the signal selector 69, the output end thereof is connected to the signal output terminal 70.

The antenna with the above-described features operates as follows.

When a wireless signal is transmitted from an on-vehicle transceiver (not shown in FIG. 6) and the transmitted wireless signal arrives at the receiving antenna of a mobile transceiver, the first ferrite chip antenna element 61 and/or the second ferrite chip antenna element 62 detects this wireless signal. At this time, a received signal with the frequency of the wireless signal is each formed in the first parallel resonant circuit 71 and/or the second parallel resonant circuit 72, because the first parallel resonant circuit 71 comprising the first ferrite chip antenna element 61 and/or the second parallel resonant circuit 72 comprising the second ferrite chip antenna element 62 are arranged to parallel-resonate with the frequency of the wireless signal. The received signal formed in the first parallel resonant circuit 71 is differentially amplified by the first differential amplifier 65 and converted into a first received signal, which is supplied to the first level detector 67 and the signal selector 69. Likewise, the received signal formed in the second parallel resonant circuit 72 is differentially amplified by the second differential amplifier 66 and converted into a second received signal, which is supplied to the second level detector 68 and the signal selector 69.

The first level detector 67 detects the level of the first received signal supplied from the first differential amplifier 65, and supplies a first detection output corresponding to the first received signal level to the signal selector 69. The second level detector 68 detects the level of the second received signal supplied from the second differential amplifier 66, and supplies a second detection output corresponding to the second received signal level to the signal selector 69. The signal selector 69 compares the magnitudes of the first and second detection outputs supplied. When the signal selector 69 determines, through the comparison, that the first detection output is larger, it selectively outputs the first received signal supplied from the first differential amplifier 65, and supplies the output to the signal output terminal 70. On the other hand, when the signal selector 69 determines, through the comparison, that the second detection output is larger, it selectively outputs the second received signal supplied from the second differential amplifier 66, and supplies the output to the signal output terminal 70. The first or second received signal supplied to the signal output terminal 70 is supplied to a received signal processing section (not shown in FIG. 6) connected to the stage next to the signal receiving section 73.

Generally, it is necessary for mobile transceivers to reduce the size and weight the components thereof and to dispose them adjacently to each other, because the mobile transceivers are, by nature, used for purpose of carrying. The known receiving antennas used for mobile transceivers are not exceptions to them. Therefore, when forming an receiving antenna, the first and second ferrite chip antenna elements 61 and 62 have also been miniaturized, and simultaneously they have been disposed adjacently to each other.

In the known receiving antennas, in order that the first and second ferrite chip antenna elements 61 and 62 can receive a wireless signal with high efficiency, the first and second ferrite chip antenna elements 61 and 62 are disposed adjacently to each other, and are arranged so that the central axes thereof intersect each other at right angles, as shown in FIG. 6. Under such an arrangement, if one end portion of the first ferrite chip antenna element 61 and that of the second ferrite chip antenna element 62 are spaced by a fixed distance apart from each other, mutual interference of magnetic fluxes hardly occurs between the first and second ferrite chip antenna elements 61 and 62, thereby presenting no problem. However, if one end portion of the first ferrite chip antenna element 61 and that of the second ferrite chip antenna element 62 are disposed adjacently to each other to reduce the size of the receiving antenna, one portion or all of the magnetic flux passing through the central axis of the first ferrite chip antenna element 61 passes through that of the second ferrite chip antenna element 62. Otherwise, one portion or all of the magnetic flux passing through the central axis of the second ferrite chip antenna element 62 passes through that of the first ferrite chip antenna element 61. Consequently, mutual interference of magnetic fluxes occurs between the first ferrite chip antenna element 61 and the second ferrite chip antenna element 62.

When the mutual interference of magnetic fluxes occurs between the first and second ferrite chip antenna elements 61 and 62, the selection characteristics of the first parallel resonant circuit 71 and/or the second parallel resonant circuit 72 become degraded than a predetermined selection characteristics, and the signal levels formed in the first parallel resonant circuit 71 and/or the second parallel resonant circuit 72 are reduced. This makes it difficult to keep the first parallel resonant circuit 71 and/or the second parallel resonant circuit 72 in a satisfactory states, resulting in a reduced reception sensitivity of the receiving antenna.

### SUMMARY OF THE INVENTION

The present invention has been made in view of the foregoing technical background, and aims to provide an arranging method for a receiving antenna of a communication device in which, when two ferrite chip antenna elements are to be arranged adjacently to each other, they are disposed so that no mutual interference of magnetic fluxes occurs therebetween, to keep the resonance characteristics of two parallel resonant circuits in satisfactory states, thereby preventing the reduction in the reception sensitivity to wireless signals.

To solve the above-described object, a method for arranging a receiving antenna according to the present invention is one in which a receiving antenna is formed by disposing two ferrite chip antenna elements adjacently to each other. This arranging method for a receiving antenna includes the step of disposing, in combination, two ferrite chip antenna elements so that a magnetic flux passing through the central axis of one of the ferrite chip antenna elements does not pass through that of the other of the ferrite chip antenna elements.

According to the above-described step, by disposing, in combination, two ferrite chip antenna elements so that a magnetic flux passing through the central axis of one of the ferrite chip antenna elements does not pass through that of the other of the ferrite chip antenna elements, the mutual interference of magnetic fluxes between the one and the other ferrite chip antenna elements is prevented from occurring. Therefore, the resonance characteristic of one parallel resonant circuit constituted of one ferrite chip antenna element and a resonance capacitor connected thereto in parallel, and the resonance characteristic of the other parallel resonant circuit constituted of the other ferrite chip antenna element and a resonance capacitor connected thereto in parallel, can be each kept in a satisfactory state. This prevents the reduction in the reception sensitivity to wireless signals, even when two ferrite chip antenna elements are disposed adjacently to each other for the miniaturization of the receiving antenna.

In this case, it is preferable that the two ferrite chip antenna elements in the above-described step be disposed in combination so as to intersect each other substantially at right angles in a state in which one end portion of one of the ferrite chip antenna elements is opposed to a side surface portion of the other of the ferrite chip antenna elements.

With these features, it is possible to reliably inhibit the occurrence of the mutual interference of magnetic fluxes between one and the other ferrite chip antenna elements. This prevents the reduction in the reception sensitivity to wireless signals, even when one and the other ferrite chip antenna elements are disposed adjacently to each other.

Also, it is preferable that the two ferrite chip antenna elements in the above-described step be disposed in combination so as to intersect each other substantially at right angles in a state in which one of the ferrite chip antenna elements and the other of the ferrite chip antenna elements overlap each other.

With these features, it is possible to reliably inhibit the occurrence of the mutual interference of magnetic fluxes between one and the other ferrite chip antenna elements, and to retain, in a minimum range, the arrangement areas of the ferrite chip antenna elements when one and the other ferrite chip antenna elements are disposed adjacently to each other. This allows the maximum miniaturization to be achieved, and prevents the reduction in the reception sensitivity to wireless signals.

The above and other objects, features, and advantages of the present invention will become clear from the following detailed description of the preferred embodiments of the invention in conjunction with the accompanying drawings.

### BRIEF DESCRIPTION OF THE DRAWINGS

FIG. 1 is a circuit construction view showing the configuration of the main section of a first embodiment of an arranging method for a receiving antenna according to the present invention, the circuit construction view being partially represented as a block diagram;

FIG. 2 is a configuration view showing one example in which first and second ferrite chip antenna elements of a receiving antenna according to the first embodiment are mounted on a circuit board;

FIG. 3 is a circuit construction view showing the configuration of the main section of a second embodiment of an arranging method for a receiving antenna according to the present invention, the circuit construction view being partially represented as a block diagram;

FIG. 4 is a configuration view showing one example in which first and second ferrite chip antenna elements of a receiving antenna according to the second embodiment are mounted on a circuit board;

FIG. 5 is a block diagram showing one example of a configuration of the main section of a mobile transceiver having the receiving antenna according to the first or second embodiment; and

FIG. 6 is a circuit construction view showing one example of a configuration of the main section of a known receiving antenna formed by combining two antenna, the circuit construction view being partially represented as a block diagram.

### DESCRIPTION OF THE PREFERRED EMBODIMENTS

Hereinafter, embodiments of the present invention will be described with reference to the accompanying drawings.

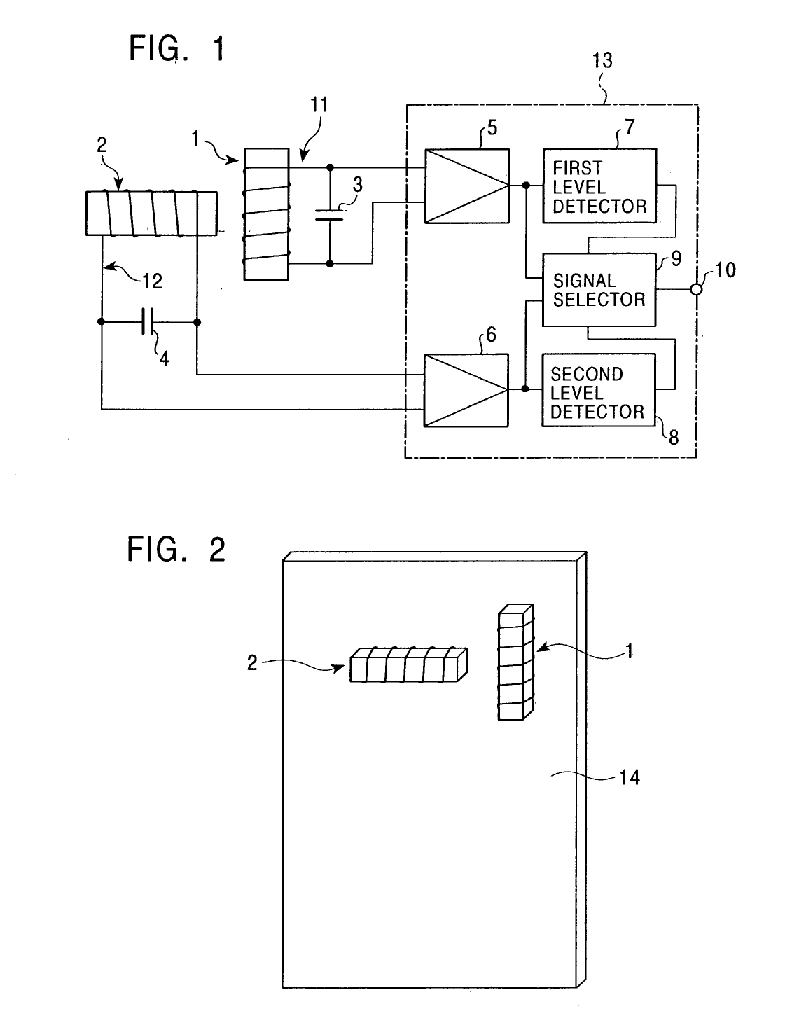

FIG. 1 is a circuit construction view showing the configuration of the main section of a first embodiment of an arranging method for a receiving antenna according to the present invention, the circuit construction view being partially represented as a block diagram.

Referring to FIG. 1, the receiving antenna according to the first embodiment includes a first ferrite chip antenna element 1, a second ferrite chip antenna element 2, a first resonance capacitor 3 connected in parallel to the first ferrite chip antenna element 1, a second resonance capacitor 4 connected in parallel to the second ferrite chip antenna element 2, a first differential amplifier 5, a second differential amplifier 6, a first level detector 7, a second level detector 8, a signal selector 9, and a signal output terminal 10. Here, a first parallel resonant circuit 11 is constituted of the first ferrite chip antenna element 1 and the first resonance capacitor 3, and a second parallel resonant circuit 12 is constituted of the second ferrite chip antenna element 2 and the second resonance capacitor 4. A signal receiving section 13 comprises the first differential amplifier 5, the second differential amplifier 6, the first level detector 7, the second level detector 8, the signal selector 9, and the signal output terminal 10. Here, the form of arrangement of the first ferrite chip antenna element 1 and the second ferrite chip antenna element 2 is such that they are disposed in combination so as to intersect each other substantially at right angles in a state in which one end portion of the second ferrite chip antenna element 2 is opposed to a side surface portion of the first ferrite chip antenna element 1. If the distance between the one end portion of the second ferrite chip antenna element 2 and the side surface portion of the first ferrite chip antenna element 1 is selected to be in a range of 1.5 to 2.5 mm, not only the resonance characteristic of the first parallel resonant circuit 11 and that of the second parallel resonant circuit 12 can be each prevented from deteriorating, but also the reduction in size is desirably achieved, as describes later.

In the first differential amplifier 5, the first input end thereof is connected to one end of the first parallel resonant circuit 11, the second input end thereof is connected to the other end of the first parallel resonant circuit 11, and the output end thereof is connected to the input end of the first level detector 7 and the first input end of the signal selector 9. In the second differential amplifier 6, the first input end thereof is connected to one end of the second parallel resonant circuit 12, the second input end thereof is connected to the other end of the second parallel resonant circuit 12, and the output end thereof is connected to the input end of the second level detector 8 and the second input end of the signal selector 9. In the first level detector 7, the output end thereof is connected to the first control end of the signal selector 9, and in the second level detector 8, the output end thereof is connected to the second control end of the signal selector 9. In the signal selector 9, the output end thereof is connected to the signal output terminal 10.

FIG. 2 is a configuration view showing one example in which first and second ferrite chip antenna elements 1 and 2 of a receiving antenna according to the first embodiment are mounted on a circuit board.

In FIG. 2, reference numeral 14 denotes a circuit board. In the rest thereof, the same components as those shown in FIG. 1 are designated by the same reference numerals.

Referring to FIG. 2, the first ferrite chip antenna element 1 and the second ferrite chip antenna element 2 are disposed in combination on one surface of the circuit board 14 so that the central axes thereof intersect each other substantially at right angles, and simultaneously, so that one end portion of the second ferrite chip antenna element 2 is opposed to the central area of a side surface portion of first ferrite chip antenna element 1.

The receiving antenna with the above-described features according to the first embodiment operates as follows.

The operation of the receiving antenna according to the first embodiment is essentially the same as that of the above-described known receiving antenna. When a wireless signal is transmitted from an on-vehicle transceiver (not shown in FIG. 1) and the transmitted signal arrives at the receiving antenna of a mobile transceiver, the first ferrite chip antenna element 1 and/or the second ferrite chip antenna element 2 detects this wireless signal. At this time also, a received signal at the frequency of the wireless signal is each formed in the first parallel resonant circuit 11 and/or the second parallel resonant circuit 12, because the first parallel resonant circuit 11 comprising the first ferrite chip antenna element 1 and/or the second parallel resonant circuit 12 comprising the second ferrite chip antenna element 2 are arranged to parallel-resonate with the frequency of the wireless signal. The received signal formed in the first parallel resonant circuit 11 is differentially amplified by the first differential amplifier 5 and converted into a first received signal, which is supplied to the first level detector 7 and the signal selector 9. Similarly, the received signal formed in the second parallel resonant circuit 12 is differentially amplified by the second differential amplifier 6 and converted into a second received signal, which is supplied to the second level detector 8 and the signal selector 9.

The first level detector 7 detects the level of the first received signal supplied from the first differential amplifier 5, and supplies a first detection output corresponding to the first received signal level to the signal selector 9. The second level detector 8 detects the level of the second received signal supplied from the second differential amplifier 6, and supplies a second detection output corresponding to the second received signal level to the signal selector 9. The signal selector 9 compares the magnitudes of the first and second detection outputs supplied. When the signal selector 9 determines, through the comparison, that the first detection output is larger, it selectively outputs the first received signal supplied from the first differential amplifier 5, and supplies the output to the signal output terminal 10. On the other hand, when the signal selector 9 determines, through the comparison, that the second detection output is larger, it selectively outputs the second received signal supplied from the second differential amplifier 6, and supplies the output to the signal output terminal 10. The first or second received signal supplied to the signal output terminal 10 is supplied to a received signal processing section (not shown in FIG. 1) connected to the stage next to the signal receiving section 13.

When the above-described operation is performed, upon formation of the received signal in the first parallel resonant circuit 11, a magnetic flux passing through the central axis of the first ferrite chip antenna element 1 occurs, and likewise, upon formation of the received signal in the second parallel resonant circuit 12, a magnetic flux passing through the central axis of the second ferrite chip antenna element 2 occurs. Herein, the first ferrite chip antenna element 1 and the second ferrite chip antenna element 2 are disposed in combination so that the central axes thereof intersect each other substantially at right angles, and simultaneously so that one end portion of the second ferrite chip antenna element 2 is adjacently opposed to the central area of the side surface portion of first ferrite chip antenna element 1. Therefore, the magnetic flux passing through the central axis of the first ferrite chip antenna element 1 and radiated into space from one end portion and the other end portion thereof, heads in directions going away from one end portion and the other end portion of the second ferrite chip antenna element 2. Similarly, the magnetic flux passing through the central axis of the second ferrite chip antenna element 2 and radiated into space from one end portion thereof, arrives at the intermediate portion of the first ferrite chip antenna element 1, but does not pass through the central axis of the first ferrite chip antenna element 1, and bypasses it. On the other hand, the magnetic flux radiated into space from the other end portion of the second ferrite chip antenna element 2, heads in a direction going away from one end portion and the other end portion of the ferrite chip antenna element 1. This eliminates the occurrence of the mutual interference of magnetic fluxes between the first and second ferrite chip antenna elements 1 and 2, and prevents the deterioration of the resonance characteristic of each of the first and second parallel resonant circuits 11 and 12, thereby providing a receiving antenna causing no reduction in reception sensitivity to wireless signals.

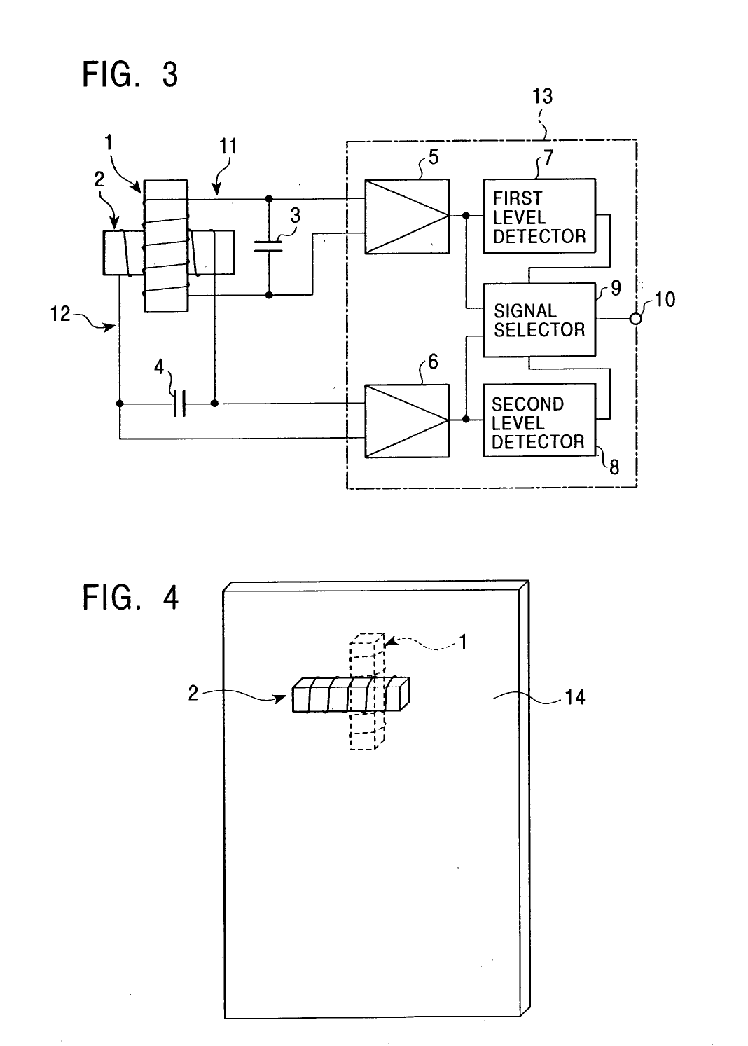

FIG. 3 is a circuit construction view showing the configuration of the main section of a second embodiment of an arranging method for a receiving antenna according to the present invention, the circuit construction view being partially represented as a block diagram.

FIG. 4 is a configuration view showing one example in which first and second ferrite chip antenna elements 1 and 2 according to the second embodiment are mounted on a circuit board.

In FIGS. 3 and 4, the same components as those shown in FIGS. 1 and 2 are designated by the same reference numerals.

As shown in FIGS. 3 and 4, the difference in the configuration between a receiving antenna according to the second embodiment (hereinafter referred to as a “second embodiment antenna”) and the antenna according to the first embodiment illustrated in FIG. 1 (hereinafter referred to as a “first embodiment antenna”) is only a difference in the arranged state between the first ferrite chip antenna element 1 and the second ferrite chip antenna element 2. With regard to the configurations other than the arranged state, there is no difference between the first embodiment antenna and the second embodiment antenna.

Specifically, in the first embodiment antenna, when the first and second ferrite chip antenna elements 1 and 2 are to be arranged so as to intersect each other substantially at right angles, they are disposed so that one end portion of the second ferrite chip antenna element 2 is adjacently opposed to the intermediate area of the side surface portion of the first ferrite chip antenna element 1. On the other hand, in the second embodiment antenna, when the first and second ferrite chip antenna elements 1 and 2 are to be arranged so as to intersect each other substantially at right angles, they are disposed so as to vertically overlap each other, and preferably so that the second ferrite chip antenna element 2 is disposed on one surface side (the top surface side) of a circuit board 14 while the first ferrite chip antenna element 1 is disposed on the other surface side (the bottom surface side) thereof.

Here, the processing operation for a wireless signal and the processing operation for a received signal in the second embodiment are the same as those in the first embodiment described above, since the configuration of the second embodiment antenna is substantially the same as that of the first embodiment antenna. Therefore, the description of the processing operation for a wireless signal and the processing operation for a received signal in the second embodiment overlaps with the description of those in the first embodiment described above. Hence, the detecting operation and processing operation for a received signal in the second embodiment is omitted from explanation.

Also in the second embodiment antenna with such features, the magnetic flux passing through the central axis of the first ferrite chip antenna element 1 and radiated into space from one end portion and the other end portion thereof, heads in directions going away from one end portion and the other end portion of the second ferrite chip antenna element 2. Also, the magnetic flux passing through the central axis of the second ferrite chip antenna element 2 and radiated into space from one end portion and the other end portion thereof, heads in directions going away from one end portion and the other end portion of the first ferrite chip antenna element 1. As a result, also in the second embodiment antenna, the occurrence of the mutual interference of magnetic fluxes between the first and second ferrite chip antenna elements 1 and 2 is eliminated, and the deterioration of the resonance characteristic of each of the first parallel resonant circuit 11 and the second parallel resonant circuit 12 is prevented. This makes it possible to achieve a receiving antenna causing no reduction in the reception sensitivity to wireless signals, and to retain the arrangement area of the two ferrite chip antenna elements 1 and 2 in a minimum range when the first and second ferrite chip antenna elements 1 and 2 are adjacently disposed to each other, thereby allowing the maximum miniaturization to be attained.

In this second embodiment, when the first and second ferrite chip antenna elements 1 and 2 are to be caused to vertically overlap each other, the first and second ferrite chip antenna elements 1 and 2 may be spaced on one surface side of the circuit board 14 apart from each other by a space of a minute distance, instead of being disposed on the opposite surfaces of the circuit board 14 with the circuit board 14 therebetween as shown in FIG. 4.

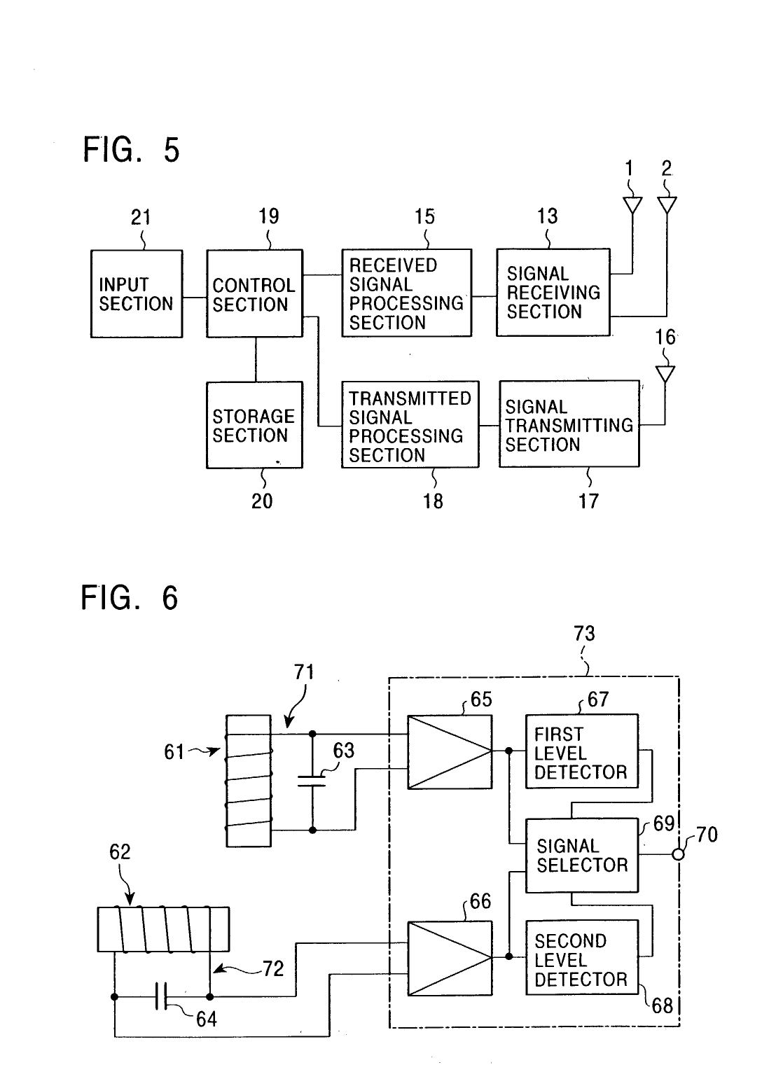

FIG. 5 is a block diagram showing one example of a configuration of the main section of a mobile transceiver having the receiving antenna according to the first or second embodiment.

Referring to FIG. 5, the mobile transceiver includes a signal receiving section 13 having two receiving antenna elements 1 and 2, a received signal processing section 15, a signal transmitting section 17 having one high-frequency antenna 16, a transmitted signal processing section 18, a control section 19, a storage section 20, and an input section 21.

Here, the received signal processing section 15 is operable to process a received signal obtained by the, reception of a wireless signal and to supply the processed result as received data to the control section 19. The signal transmitting section 17 is operable to form a transmitted wireless signal to be transmitted to an onvehicle transceiver (not shown in FIG. 5) through the highfrequency antenna 16. The transmitted signal processing section 18 is operable to process transmitted data supplied from the control section 19 and to form a signal suited for transmission. The control section 19 is operable to perform a centralized control of the operation of all sections. The storage section 20 stores required data and computation results under the control of the control section 19. The input section 21 produces operation signals based on the operation of various operating sections, and supplies the operation signals to the control section.

Herein, because the configuration and the operation of the mobile transceiver is each well known to those skilled in the art, they are not described here any more.

While the present invention has been described with reference to what are at present considered to be the preferred embodiments, it is to be understood that various changes and modifications may be made thereto without departing from the present invention in its broader aspects and therefore, it is intended that the appended claims cover all such changes and modifications that fall within the true spirit and scope of the invention.

What is claimed is:

1. A method for arranging a receiving antenna disposed two ferrite chip antenna elements adjacently to each other comprising: arranging said two ferrite chip antenna elements so that a magnetic flux passing through the central axis of one of said ferrite chip antenna elements does not pass through that of the other of said ferrite chip antenna elements.

2. A method for arranging a receiving antenna according to claim 1, wherein said two ferrite chip antenna elements are disposed in combination so as to intersect each other substantially at right angles in a state in which one end portion of said one ferrite chip antenna element is opposed to a side surface portion of said other ferrite chip antenna element.

3. A method for arranging a receiving antenna according to claim 1, wherein said two ferrite chip antenna elements are disposed in combination so as to intersect each other substantially at right angles in a state in which said one ferrite chip antenna element and said other ferrite chip antenna element overlap each other.

4. A method for arranging a receiving antenna according to claim 3, wherein said two ferrite chip antenna elements are disposed at respective opposite positions on the opposite surfaces of a circuit board.

5. A receiving antenna comprising: two ferrite chip antenna elements arranged such that a magnetic flux passing through the central axis of one of said ferrite chip antenna elements does not pass through that of the other of said ferrite chip antenna elements.

6. A receiving antenna according to claim 5, wherein said two ferrite chip antenna elements are disposed in combination so as to intersect each other substantially at right angles in a state in which one end portion of said one ferrite chip antenna element is opposed to a side surface portion of said other ferrite chip antenna element.

7. A receiving antenna according to claim 5, wherein said two ferrite chip antenna elements are disposed in combination so as to intersect each other substantially at right angles in a state in which said one ferrite chip antenna element and said other ferrite chip antenna element overlap each other.

8. A receiving antenna according to claim 5, wherein said two ferrite chip antenna elements are disposed at respective opposite positions on the opposite surfaces of a circuit board.
